(19) United States
(12) Patent Application Publication
(10) Pub. No.: US 2024/0037000 A1
(43) Pub. Date: Feb. 1, 2024

(54) AUTOMATIC IDENTIFICATION OF REUSABLE HARDWARE COMPONENTS

(71) Applicant: INTERNATIONAL BUSINESS MACHINES CORPORATION, ARMONK, NY (US)

(72) Inventors: Sudheesh S. Kairali, Kozhikode (IN); Sarbajit K. Rakshit, Kolkata (IN)

(21) Appl. No.: 17/814,862

(22) Filed: Jul. 26, 2022

(51) Int. Cl. G06F 11/26; G06F 11/22

(52) U.S. Cl. CPC G06F 11/261; G06F 11/2289

(57) ABSTRACT

A processor may identify that an apparatus is to be disposed. The apparatus may be composed of one or more hardware components. The processor may analyze the apparatus. The processor may generate a respective digital twin for each of the one or more hardware components. The processor may analyze the respective digital twin for each of the one or more hardware components. The processor may determine a condition of each of the one or more hardware components based on the respective digital twin for each of the one or more hardware components.

### BACKGROUND

The present disclosure relates generally to the field of manufacturing, and more specifically to automatic identification of reusable hardware components for machines.

In any industrial floor, there can be different types of machines/apparatuses, and different types of machines may be performing different types of activities in the industrial floor. In such a case, in various situations, one or more machines can be scrapped, or can become obsolete such that the machines are not used, which leads to waste.

### SUMMARY

Embodiments of the present disclosure include a method, computer program product, and system for identifying reusable hardware components. A processor may identify that an apparatus is to be disposed. The apparatus may be composed of one or more hardware components. The processor may analyze the apparatus. The processor may generate a respective digital twin for each of the one or more hardware components. The processor may analyze the respective digital twin for each of the one or more hardware components. The processor may determine a condition of each of the one or more hardware components based on the respective digital twin for each of the one or more hardware components.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example system for identifying reusable hardware components, in accordance with aspects of the present disclosure.

FIG. 2 illustrates a flowchart of an example method for identifying reusable hardware components, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of manufacturing, and more specifically to automatic identification of reusable hardware components for machines. While the present disclosure is not necessarily limited to such applications, various aspects of the disclosure may be appreciated through a discussion of various examples using this context.

In any industrial floor, there can be different types of machines/hardware, and different types of machines may be performing different types of activities in the industrial floor. In such a case, in various situations, one or more machines can be scrapped, or can become obsolete such that the machines are not used, which can lead to waste. Even if one or more machines are scrapped, some parts of the machines can still be utilized, either in another machine or for another purpose, however.

Consequently, in any industrial floor, if one or more machines (e.g., sometimes referred to herein as an apparatus or apparatuses) are scrapped, or about to become obsolete, then there is also a possibility to utilize parts (e.g., sometimes referred to herein as hardware components or components) of the said apparatus to another apparatus. In such a case, the components of the apparatus can be utilized to support or be a portion of the working apparatus (e.g., such as a gear box having a set of spare parts working together) or a spare part (e.g., like a bolt). However, with such reuse being possible, there creates a need to identify where the components of an obsolete/scrapped apparatus can be used, or if the components should be stored as spare parts for later use.

Accordingly, discussed herein is a solution for automatically identifying reusable hardware components. Said solution, by way of a processor, provides that if any apparatus is to be scrapped (e.g., disposed), then a digital twin computing system will perform a digital twin simulation of each and every components of the apparatus to identify which components can be reused in other apparatuses.

In some embodiments, the solution further performs a digital twin simulation of each and every apparatus within a surrounding/environment (e.g., industrial floor, research station, etc.), and according identifies which components of the apparatus can be replaced by components of a disposed apparatus.

Further, in some embodiments, the solution considers the digital twin model of different apparatus' components, either functioning or disposed, to identify if those components can be assembled together to generate/build a new apparatus to solve a different problem or can be used for any activity (e.g., can disposed machines used for plastic extrusion have their components reassembled to perform more plastic extrusion or another form of plastic molding, etc.).

In some embodiments, the solution analyzes historical ordering of different components for different apparatuses, and accordingly identifies if any component of a disposed machine can be stored for future usage as a spare part (e.g., a gear from an obsolete machine is modular and can work for various other machines, but no other gears are needed at a particular time, the gear is then stored for future use.).

In some embodiments, the solution analyzes a disposed apparatus (e.g., scrapped or obsolete machines), and accordingly identifies which types of changes can be applied on the disposed apparatus such that the disposed apparatus can be converted to a different type of apparatus and can perform different activities in its surroundings (e.g., industrial floor).

In some embodiments, the solution identifies different types of activities that are performed in/on an industrial floor or any environment/surround, and accordingly, based on historical learning about different types of apparatus structure, mechanical advantages, etc., identifies how components (e.g., spare parts and components from obsolete apparatuses) can be used for generating different machines.

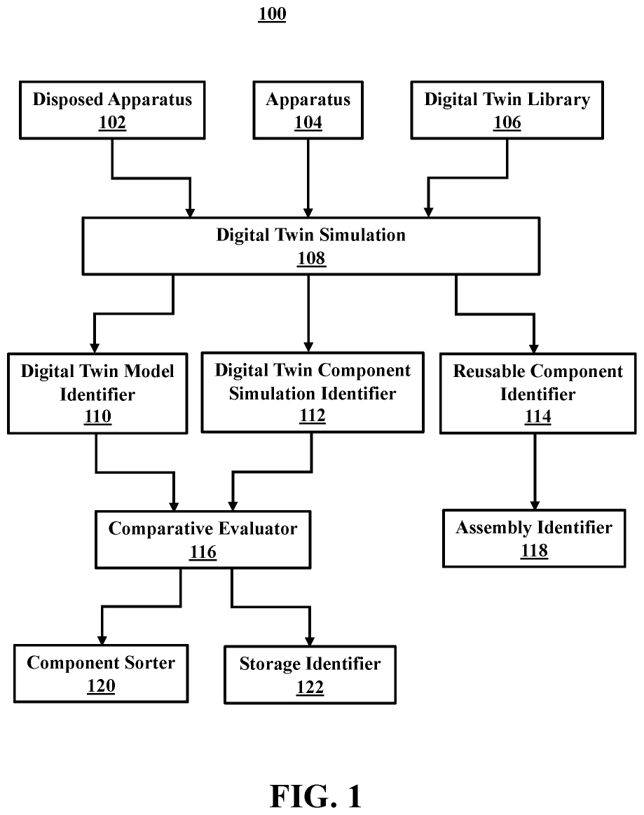

Referring now to FIG. 1, illustrated is a block diagram of an example system 100 for identifying reusable hardware components, in accordance with aspects of the present disclosure.

As depicted, the system 100 includes a disposed apparatus 102, an apparatus 104, a digital twin library 106, a digital twin simulation 108, a digital twin model identifier 110, a digital twin component simulation identifier 112, a reusable component identifier 114, a comparative evaluator 116, an assembly identifier 118, a component sorter 120, and a storage identifier 122.

In some embodiments, the system 100 identifies that the disposed apparatus 102 (or multiple apparatuses) is made obsolete, slated to become obsolete, or that will be scrapped. The system 100 further identifies the apparatus 104 (and/or other apparatuses) in a surrounding (e.g., industrial floor) that is still working, or not slated to become obsolete and further accesses the digital twin library 106 that includes digital twins of different types of apparatuses, the apparatuses' associated components, and the apparatuses and their associated components' functions.

In some embodiments, the disposed apparatus 102, the apparatus 104, and the digital twin library 106 are ingested by the system 100 to generate the digital twin simulation 108. The system 100 utilizes the digital twin simulation 108 in conjunction with the digital twin model identifier 110 to identify various digital twins of the disposed apparatus 102, the apparatus 104, and their associated components. The system 100 further utilizes the digital twin simulation 108 in conjunction with the digital twin component simulation identifier 112 to identify simulations of various functions and uses of the disposed apparatus 102, the apparatus 104, and their associated components. In some embodiments, the system 100 further utilizes the digital twin simulation 108 in conjunction with the reusable component identifier 114 to identify excess/spare components (parts) from the disposed apparatus 102.

In some embodiments, the system 100 provides the information from the reusable component identifier 114 to the assembly identifier 118, which identifies which types of new apparatuses can be generated from various components/spare parts/etc.

In some embodiments, the system 100 provides the information from the digital twin model identifier 110 and the digital twin component simulation identifier 112 to the comparative evaluator 116, which evaluates each digital twin of the disposed apparatus 102, the apparatus 104, and their associated components, and determines which components are the highest quality (e.g., the disposed apparatus 102 has 4 chrome bolts, and one bolt is next to new, the one bolt is the evaluated as being a better reusable component than the others).

In some embodiments, information from the comparative evaluator 116 is then evaluated by the component sorter 120, which determines which components are to be scraped or reused. The information from the comparative evaluator 116 is also evaluated by the storage identifier 122, which identifies which components are to be stored for later usage.

As an example of the system 100, in some embodiments, in any industrial floor, each and every apparatus (e.g., including disposed apparatus 102 and apparatus 104) will be uniquely identified, analyzed and labeled; and the digital twin library 106 will store digital twin models of each and every apparatus component, part, spare parts, etc.

In some embodiments, based on the functionality of different combinations of components (spare parts) the system 100 will classify different components of the disposed apparatus 102 and/or apparatus 104, such as, mechanical power transmission system, balancing system, etc. Different components of the disposed apparatus 102 and/or apparatus 104 can be generated with different combinations of components and working with appropriate sequences of components (e.g., this bolt must be in this slot before this other bolt can be placed, etc.).

In some embodiments, the system 100 will be gathering IoT feeds from the components to generate a digital twin model at a granular level. The system 100 will then determine if any apparatus is to be scrapped or is to be made obsolete, and if a new apparatus is to be installed. In such an embodiment, the system 100 may utilize any of the digital twin model identifier 110, the digital twin component simulation identifier 112, the reusable component identifier 114, the comparative evaluator 116, the assembly identifier 118, the component sorter 120, and/or the storage identifier 122 for such a determination.

In some embodiments, the system 100 will identify all possible apparatuses on the industrial floor and will generate a bill of material for each of the apparatuses. In some embodiments, the system 100 will identify each and every component in different apparatuses.

The system 100 can further identify the any apparatus (e.g., the disposed apparatus 102) is to be made obsolete, replaced, or scrapped. In such an embodiment, the system 100 will identify what types of (hardware) components of the disposed apparatus 102 are the same as other apparatuses (e.g., the apparatus 104) in the industrial floor.

In some embodiments, the system 100 will consider the health of the disposed apparatus 102's components, and determine if they are to be reusable, obsolete, or scrapped (e.g., disposed of). The system 100 will the perform comparative evaluation (e.g., from the comparative evaluator 116) of the components

In some embodiments, the system 100 will identify which components can be reused in other apparatuses (e.g., which components of the disposed apparatus 102 can be used in/by the apparatus 104). In such an embodiment, the system 100 has access to the cloud hosted digital twin library 106, which includes different types of machines/apparatuses, their structures/components/usages, etc.

In some embodiments, the system 100 will identify different types of activities that can be performed in/on the industrial floor, and based on historically gathered feeds from various activities, the system 100 will identify how the activities are performed (e.g., by the apparatuses on the industrial floor).

In some embodiments, the system 100 will gather IoT feeds from various activities and will calculate the different amounts of force, torque, etc. that are applied by the apparatuses (e.g., the apparatus 104) while performing the activities. The system 100 will access digital twin models of various apparatuses and will identify how the activities can be performed with different types of apparatuses (e.g., can a metal rod from a lathe, be used from stamping on another machine?, etc.).

In some embodiments, the system 100 will be identify components from the obsolete machine (e.g., the disposed apparatus 102) and will identify if a new apparatus can be developed/generated with those components. The system 100 will also identify how the new apparatus can make one or more current activity in a better way (e.g., if a thicker spring is used can production increase?, etc.). In some embodiments, the system 100 will show the components from various disposed apparatuses (e.g., disposed apparatus 102) that can be assembled to create a new apparatus to help the current activity. In such embodiments, the system 100 may utilize the assembly identifier 118 to generated and/or assemble the new apparatus.

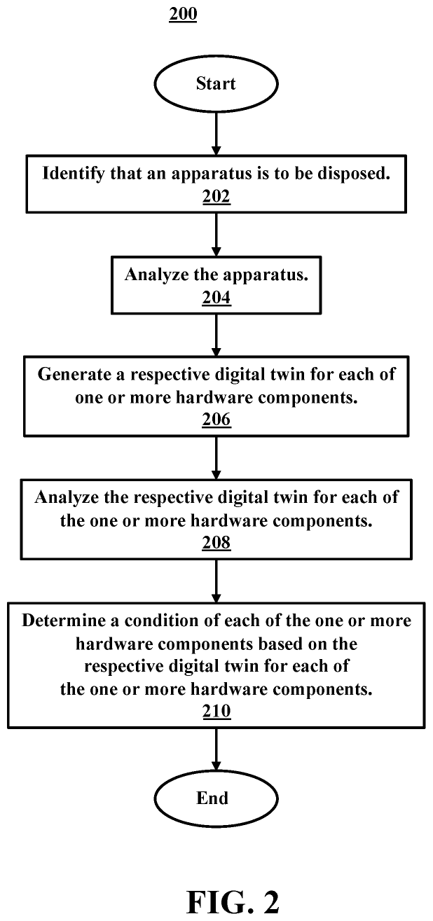

Referring now to FIG. 2, illustrated is a flowchart of an example method 200 for identifying reusable hardware components, in accordance with aspects of the present disclosure. In some embodiments, the method 200 may be performed by a processor (e.g., of the system 100 of FIG. 1, etc.).

In some embodiments, the method 200 begins at operation 202, where the processor may identify that an apparatus is to be disposed. The apparatus may be composed of one or more hardware components. In some embodiments, the method 200 proceeds to operation 204, where the processor may analyze the apparatus.

In some embodiments, the method 200 proceeds to operation 206, where the processor may generate a respective digital twin for each of the one or more hardware components. In some embodiments, the method 200 proceeds to operation 208, where the processor may analyze the respective digital twin for each of the one or more hardware components.

In some embodiments, the method 200 proceeds to operation 210, where the processor may determine a condition of each of the one or more hardware components based on the respective digital twin for each of the one or more hardware components.

In some embodiments, discussed below, there are one or more operations of the method 200 not depicted for the sake of brevity and which are discussed throughout this disclosure. Accordingly, in some embodiments, determining the condition of each of the one or more hardware components includes the processor identifying that a condition of a first hardware component is unusable and disposing the first hardware component.

In some embodiments, determining the condition of each of the one or more hardware components includes the processor identifying that a condition of a first hardware component is reusable and storing the first hardware component. In such an embodiment, the first hardware component may be stored with other reusable hardware components.

In some embodiments, the method 100 may further involve the processor analyzing a second apparatus, where the second apparatus is composed of one or more other hardware components. The processor may further generate other respective digital twins for each of the one or more other hardware components and determine if any of the one or more other hardware components should be replaced.

In some embodiments, the method 100 may further involve the processor identifying that a first other hardware component should be replaced. The processor may further compare the first hardware component with the first other hardware component, identify that the first hardware component and the first other hardware component are the same and replace the first other hardware component with the first hardware component.

In some embodiments, the method 100 may further involve the processor analyzing one or more other apparatuses. The processor may further identify a common function between the apparatus and the one or more other apparatuses, and analyze the stored hardware components.

In some embodiments, the processor may further determine, from the analyzing of the stored hardware components, that a new apparatus can be assembled, and the processor may assemble the new apparatus from the stored hardware components.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

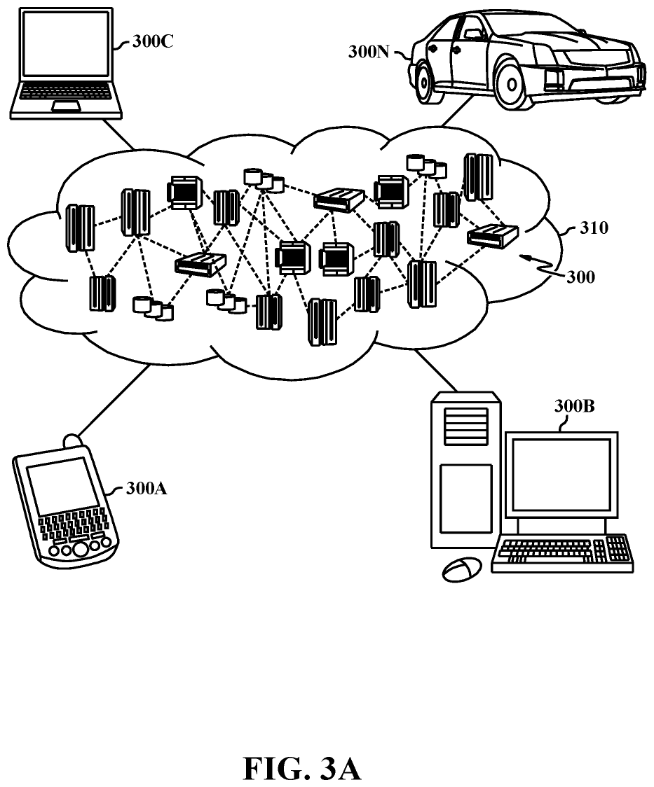

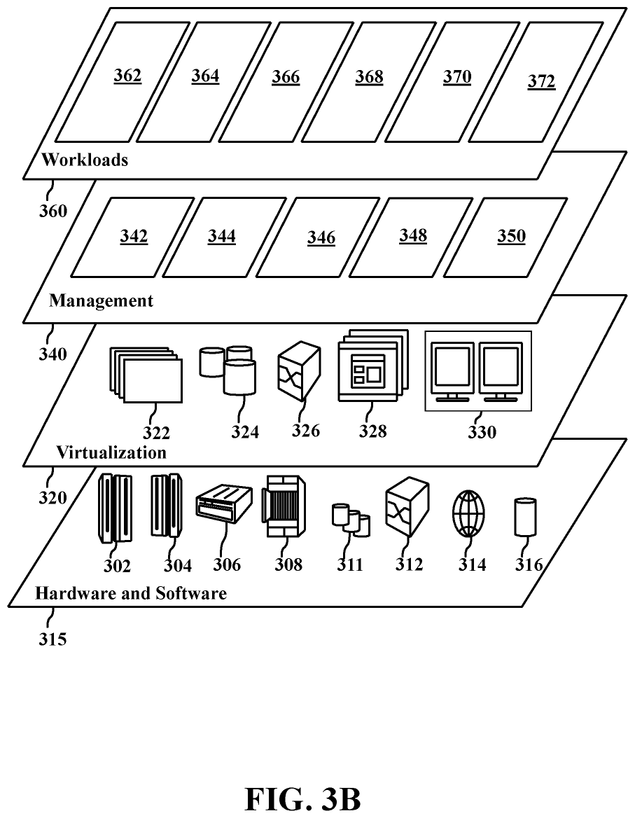

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and reusable hardware component identification 372.

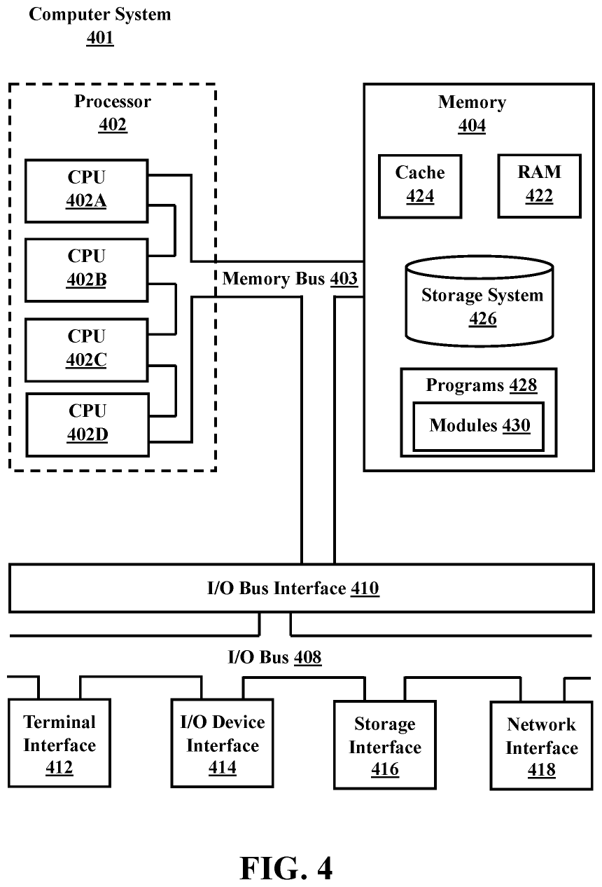

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A system for identifying reusable hardware components, the system comprising:
a memory; and
a processor in communication with the memory, the processor being configured to perform operations comprising:
identifying that an apparatus is to be disposed, wherein the apparatus is composed of one or more hardware components;
analyzing the apparatus;
generating a respective digital twin for each of the one or more hardware components;
analyzing the respective digital twin for each of the one or more hardware components; and
determining a condition of each of the one or more hardware components based on the respective digital twin for each of the one or more hardware components.

2. The system of claim 1, wherein determining the condition of each of the one or more hardware components includes:
identifying that a condition of a first hardware component is unusable; and
disposing the first hardware component.

3. The system of claim 1, wherein determining the condition of each of the one or more hardware components includes:
identifying that a condition of a first hardware component is reusable; and
storing the first hardware component, wherein the first hardware component is stored with other reusable hardware components.

4. The system of claim 3, wherein the processor is further configured to perform operations comprising:
analyzing a second apparatus, wherein the second apparatus is composed of one or more other hardware components;
generating other respective digital twins for each of the one or more other hardware components; and
determining if any of the one or more other hardware components should be replaced.

5. The system of claim 4, wherein the processor is further configured to perform operations comprising:
identifying that a first other hardware component should be replaced;
comparing the first hardware component with the first other hardware component;
identifying that the first hardware component and the first other hardware component are the same; and
replacing the first other hardware component with the first hardware component.

6. The system of claim 3, wherein the processor is further configured to perform operations comprising:
analyzing one or more other apparatuses;
identifying a common function between the apparatus and the one or more other apparatuses; and
analyzing the stored hardware components.

7. The system of claim 6, wherein the processor is further configured to perform operations comprising:
determining, from the analyzing of the stored hardware components, that a new apparatus can be assembled; and
assembling the new apparatus from the stored hardware components.

8. A computer-implemented method for identifying reusable hardware components, the method comprising:
identifying, by a processor, that an apparatus is to be disposed, wherein the apparatus is composed of one or more hardware components;
analyzing the apparatus;
generating a respective digital twin for each of the one or more hardware components;
analyzing the respective digital twin for each of the one or more hardware components; and
determining a condition of each of the one or more hardware components based on the respective digital twin for each of the one or more hardware components.

9. The computer-implemented method of claim 8, wherein determining the condition of each of the one or more hardware components includes:
identifying that a condition of a first hardware component is unusable; and
disposing the first hardware component.

10. The computer-implemented method of claim 8, wherein determining the condition of each of the one or more hardware components includes:
identifying that a condition of a first hardware component is reusable; and
storing the first hardware component, wherein the first hardware component is stored with other reusable hardware components.

11. The computer-implemented method of claim 10, further comprising:
analyzing a second apparatus, wherein the second apparatus is composed of one or more other hardware components;
generating other respective digital twins for each of the one or more other hardware components; and
determining if any of the one or more other hardware components should be replaced.

12. The computer-implemented method of claim 11, further comprising:
identifying that a first other hardware component should be replaced;
comparing the first hardware component with the first other hardware component;
identifying that the first hardware component and the first other hardware component are the same; and
replacing the first other hardware component with the first hardware component.

13. The computer-implemented method of claim 10, further comprising:
analyzing one or more other apparatuses;
identifying a common function between the apparatus and the one or more other apparatuses; and
analyzing the stored hardware components.

14. The computer-implemented method of claim 13, further comprising:
determining, from the analyzing of the stored hardware components, that a new apparatus can be assembled; and
assembling the new apparatus from the stored hardware components.

15. A computer program product for identifying reusable hardware components comprising a computer readable storage medium having program instructions embodied therewith, the program instructions executable by a processor to cause the processor to perform operations, the operations comprising:
identifying that an apparatus is to be disposed, wherein the apparatus is composed of one or more hardware components;
analyzing the apparatus;
generating a respective digital twin for each of the one or more hardware components;
analyzing the respective digital twin for each of the one or more hardware components; and
determining a condition of each of the one or more hardware components based on the respective digital twin for each of the one or more hardware components.

16. The computer program product of claim 15, wherein determining the condition of each of the one or more hardware components includes:
identifying that a condition of a first hardware component is unusable; and
disposing the first hardware component.

17. The computer program product of claim 15, wherein determining the condition of each of the one or more hardware components includes:
identifying that a condition of a first hardware component is reusable; and
storing the first hardware component, wherein the first hardware component is stored with other reusable hardware components.

18. The computer program product of claim 17, wherein the processor is further configured to perform operations comprising:
analyzing a second apparatus, wherein the second apparatus is composed of one or more other hardware components;
generating other respective digital twins for each of the one or more other hardware components; and
determining if any of the one or more other hardware components should be replaced.

19. The computer program product of claim 18, wherein the processor is further configured to perform operations comprising:
identifying that a first other hardware component should be replaced;
comparing the first hardware component with the first other hardware component;
identifying that the first hardware component and the first other hardware component are the same; and
replacing the first other hardware component with the first hardware component.

20. The computer program product of claim 17, wherein the processor is further configured to perform operations comprising:
analyzing one or more other apparatuses;
identifying a common function between the apparatus and the one or more other apparatuses; and
analyzing the stored hardware components.
